(19) United States
(12) Patent Application Publication
(10) Pub. No.: US 2022/0062882 A1
(43) Pub. Date: Mar. 3, 2022

(54) METAL TRAPPING ADDITIVE

(71) Applicant: Johnson Matthey Process Technologies, Inc., Savannah, GA (US)

(72) Inventors: Mehdi ALLAHVERDI, Savannah, GA (US); Ashish BAMBAL, Savannah, GA (US); Paul DIDDAMS, Prague (CZ)

(21) Appl. No.: 17/446,538

(22) Filed: Aug. 31, 2021

Related U.S. Application Data
(60) Provisional application No. 62/706,673, filed on Sep. 2, 2020.

(51) Int. Cl. B01J 33/00; C10G 47/16

(52) U.S. Cl. CPC B01J 33/00; C10G 2300/70; C10G 2400/02; C10G 47/16

(57) ABSTRACT

The invention includes a metal trapping additive that comprises calcium, boron and magnesia-alumina. The invention also includes a process for the catalytic cracking of feedstock comprising contacting the feedstock under catalytic cracking conditions with a FCC catalyst and the metal trapping additive.

### FIELD OF THE INVENTION

The invention relates to an additive for use in a fluid catalytic cracking process, and its use in fluid catalytic cracking.

### BACKGROUND OF THE INVENTION

Refinery gasoline in the United States typically contains 35-40% gasoline produced by the fluid catalytic cracking (“FCC”) process. In the FCC process, heavy (high molecular weight) hydrocarbon fractions are converted into lighter (lower molecular weight) products by reactions taking place at high temperature in the presence of a catalyst. FCC feedstock is thereby converted into gasoline, kerosene, diesel and other liquid cracking products as well as lighter gaseous cracking products of four or fewer carbon atoms. These products, liquid and gas, consist mainly of saturated and unsaturated hydrocarbons.

In FCC processes, feedstock is typically injected into the riser section of a FCC reactor, where it is cracked into lighter, more valuable products by contacting hot catalyst that has been circulated to the riser-reactor from a catalyst regenerator. As the endothermic cracking reactions take place, coke is deposited onto the catalyst. This coke reduces the activity of the catalyst and therefore the catalyst must be regenerated to revive its activity. Catalyst and hydrocarbon vapors are carried up the riser to the disengagement section of the FCC reactor, where they are separated by cyclones: product vapors pass to the main fractionator for fractionation and recovery in the gas plant. The catalyst flows into a stripping section, where the hydrocarbon vapors entrained with the catalyst are stripped by steam injection. Following removal of occluded hydrocarbons, the stripped catalyst flows through a spent catalyst standpipe and into the catalyst regenerator.

Catalyst is regenerated by introducing air into the regenerator to burn off the coke and restore catalyst activity. Coke combustion reactions are highly exothermic and as a result, heat-up the catalyst in the regenerator. Hot, reactivated catalyst flows through the regenerated catalyst standpipe back to the riser to complete the catalyst cycle. Coke combustion exhaust gases exit the regenerator to the regenerator flue gas line. The exhaust gas generally contains trace levels of nitrogen oxides (NOₓ), sulfur oxides (SOₓ), carbon monoxide and, ammonia in addition to carbon dioxide, nitrogen, steam and excess oxygen. The catalyst is subjected to permanent deactivation in the regenerator's harsh hydrothermal environment. Typically about 2% of fresh catalyst is added to the FCC unit each day to compensate and maintain constant catalyst activity.

Coke, hydrogen and dry gas (C₁-C₂ hydrocarbons) are formed as undesired side-reactions in the FCC riser. Conversion and feed rate are usually limited by coke (air rate and regenerator temperature) and hydrogen and dry gas (wet gas compressor) constraints. Metal contaminants in feedstock deposit and accumulate on the catalyst where they promote the formation of higher levels of coke, hydrogen and dry gas, which further impact these constraints. Common metal contaminants include iron, nickel and vanadium. These metals promote dehydrogenation reactions in the riser, which results in increased amounts of coke and light gases at the expense of desired products. Vanadium can also affect its stability and crystallinity of the zeolite present in the cracking catalyst thereby reducing its activity.

Continuous catalyst replacement leads to metals levels reaching steady state levels. The usual way to deal with metals excursions is to increase catalyst additions to flush out the metals by increasing the rate of catalyst replacement. An alternative approach is to passivate metals using metal traps that are either built into the primary catalyst particles or more flexibly added in separate particles (metals trapping additives). Such metals trapping additives are designed to preferentially combine with specific metal contaminants and act as “traps” or “sinks” and passivate the metal so that the active component of the cracking catalyst is protected. Metal contaminants are then be removed along with the catalyst that is withdrawn from the unit during its normal operation. Fresh metal passivating additives can then be added to the unit, along with make-up catalyst, in order to affect a continuous withdrawal of the detrimental metal contaminants during operation of the FCC unit. Depending on the level of metal contaminants in the feedstock, the quantity of additive can be varied relative to the make-up catalyst in order to achieve the desired degree of metals passivation.

Industrial facilities are continuously trying to find new and improved methods to increase the conversion of an FCC unit while minimizing the increase in coke and H₂ byproducts. The invention is directed to trapping and passivating feed contaminant metals to protect the FCC catalyst and thereby allow operators to increase feed rate, process lower cost more highly contaminated feeds and increase conversion and product qualities.

### SUMMARY OF THE INVENTION

The invention includes a metal trapping additive comprising calcium, boron and a magnesia-alumina. The invention also includes a process for the catalytic cracking of feedstock comprising contacting the feedstock under catalytic cracking conditions with a FCC catalyst and a metal trapping additive comprising calcium, boron and magnesia-alumina.

### DETAILED DESCRIPTION OF THE INVENTION

The invention includes a metal trapping additive comprising calcium, boron and magnesia-alumina.

The magnesia-alumina is preferably a mixed magnesium-aluminum oxide, a spinel, a hydrotalcite or hydrotalcite-like material, and combinations of two or more thereof. More preferably, the magnesia-alumina is a hydrotalcite or a hydrotalcite-like material.

The hydrotalcite or hydrotalcite-like material (HTL) may be collapsed, dehydrated, calcined, and or dehydroxylated. Non-limiting examples and methods for making various types of HTL are described in U.S. Pat. Nos. 6,028,023; 6,479,421; 6,929,736; and 7,112,313; which are incorporated by reference herein in their entirety. Other non-limiting examples and methods for making various types of HTL are described in U.S. Pat. Nos. 4,866,019; 4,964,581; and 4,952,382; which are incorporated by reference herein in their entirety.

The metal trapping additive preferably has a calcium content, calculated as CaO, of 5 to 50 weight percent; more preferably 10 to 35 weight percent. The metal trapping additive preferably has a boron content, calculated as

B₂O₃, of 3 to 20 weight percent; more preferably 5 to 15 weight percent.

Preferably, the metal trapping additive has an apparent bulk density within the range of from 0.7 to 0.95 g/cc. Preferably, the metal trapping additive has an average particle size ranging from 70 to 110 microns.

The metal trapping additive is preferably prepared by mixing magnesia-alumina with calcium and boron compounds, preferably as a mixed slurry, to form the metal trapping additive. The calcium compounds preferably include calcium carbonate, calcium nitrate, calcium hydroxide, calcium acetate, calcium oxide, and the like. The boron compounds preferably include boron oxide, boric acid, boric anhydride, and the like. A mixed calcium-boron compound such as calcium metaborate can also be used. The metal trapping additive is preferably spray dried to form particles having a preferred shape and geometry.

Preferably, the metal trapping additive has no cracking activity.

The invention also includes a process for the catalytic cracking of feedstock comprising contacting the feedstock under catalytic cracking conditions with a FCC catalyst and a metal trapping additive comprising calcium, boron and magnesia-alumina.

Preferably, the catalytic cracking conditions comprise contacting the feedstock in a FCC unit that comprises a riser and a reaction section in which the FCC catalyst contacts and vaporizes a hydrocarbon feedstock. The hydrocarbon feedstock preferably enters the bottom of the riser of the FCC unit and carries the FCC catalyst and metal trapping additive up the riser into the reactor section. Cracked hydrocarbon product exits the top of the reactor and FCC catalyst particles and metal trapping additive are retained in a bed of particles in the lower part of the reactor.

The used FCC catalyst and metal trapping additive are then passed to the regenerator of the FCC unit. As used in this application, the term “regenerator” also includes the combination of a regenerator and a CO boiler, particularly when the regenerator itself is run under partial burn conditions. In the regenerator, coke on the FCC catalyst and metal trapping additive is burned off in a fluidized bed in the presence of oxygen and a fluidization gas which are typically supplied by entering the bottom of the regenerator. The regenerated FCC catalyst and metal trapping additive are withdrawn from the regenerator and returned to the riser for reuse in the cracking process.

Preferably, a circulating inventory of FCC catalyst and metal trapping additive is circulated in the catalytic cracking process, wherein from about 2% to about 20% by weight of this circulating inventory comprises the metal trapping additive as described above.

Preferably, the metal trapping additive decreases the coke production from feedstock, and also preferably decreases hydrogen gas production from feedstock.

Feedstocks for the catalytic cracking process can range from petroleum distillates or residual stocks, either virgin or partially refined, coal oils and shale oils, gas oils, vacuum gas oils, atmospheric resids, vacuum resids, biomass, coker gas oil, lube oil extracts, hydrocracker bottoms, wild naphtha, slops, and the like. The feedstock may contain recycled hydrocarbons, such as light and heavy cycle oils which have already been subjected to cracking. Preferred feedstocks include gas oils, vacuum gas oils, atmospheric resids, and vacuum resids.

The metal trapping additive and FCC catalyst may be added to the FCC unit separately or together. Metal trapping additives are preferably, but not exclusively, added to the regenerator of an FCC unit.

The metal trapping additive and FCC catalyst can be introduced into the FCC unit by manually loading from hoppers, bags or drums or using automated addition systems, as described, for example, in U.S. Pat. No. 5,389,236. To introduce the metal trapping additives to an FCC unit, the metal trapping additives can also be pre-blended with FCC catalysts and introduced into the unit as an admixture. Alternatively, the metal trapping additives and FCC catalysts can be introduced into the FCC unit via separate injection systems. In another embodiment, the metal trapping additives can be added in a varying ratio to the FCC catalyst. A varying ratio can be determined, for example, at the time of addition to the FCC unit in order to optimize the rate of addition of the metal trapping additives.

Conventional and High Severity FCC riser or downer cracking conditions, or older style FCC fluid bed reactors cracking conditions can be used. Cracking reaction conditions include catalyst/oil ratios of about 1:1 to about 30:1 and a catalyst contact time of about 0.1 to about 360 seconds, and riser top/reactor bed temperatures from about 425° C. to about 750° C.

The additives of the invention can be added to any conventional fluid bed reactor-regenerator systems, to ebullating catalyst bed systems, to systems which involve continuously conveying or circulating catalysts/additives between reaction zone and regeneration zone and the like. In one embodiment, the system is a circulating bed system. Typical of the circulating bed systems are the conventional moving bed and fluidized bed reactor-regenerator systems. Both of these circulating bed systems are conventionally used in hydrocarbon conversion (e.g., hydrocarbon cracking) operations. In one embodiment, the system is a fluidized catalyst bed reactor-regenerator system.

Other specialized riser-regenerator systems that can be used herein include deep catalytic cracking (DCC), millisecond catalytic cracking (MSCC), high severity petrochemical FCC resid fluid catalytic cracking (RFCC) systems, Superflex, Advanced Catalytic Olefins, and the like.

The FCC catalyst of the invention means any catalyst which can be used for operating an FCC unit under all types of catalytic cracking conditions. Any commercially available FCC catalyst can be used as the FCC catalyst. The FCC catalyst can be 100% amorphous, but in one embodiment, can include some zeolite in a porous refractory matrix such as silica-alumina, clay, or the like. The zeolite is usually from about 5 to about 70% of the catalyst by weight, with the rest being matrix. Conventional zeolites such as Y zeolites, or aluminum deficient forms of these zeolites, such as dealuminated Y, ultrastable Y and ultrahydrophobic Y, can be used. The zeolites can be stabilized with magnesium or rare earths, for example, in an amount of from about 0.1 to about 10% by weight.

The zeolites that can be used herein include both natural and synthetic zeolites.

Relatively high silica zeolite containing catalysts can be used in the invention. They can withstand the high temperatures usually associated with complete combustion of coke to CO₂ within the FCC regenerator. Such catalysts include those typically containing about 10 to about 70% ultrastable Y or rare earth ultrastable Y.

The metal trapping additive for use in the process of the invention is the additive described above.

Other additives may be used in the process of the invention in addition to the FCC catalyst and the metal trapping additive of the present invention. Preferably, these additional additives can be added to enhance octane, such as medium pore size zeolites, e.g., ZSM-5 and other materials having a similar crystal structure. Additives can also be added to promote CO combustion; to reduce SOₓ emissions, NOₓ emissions and/or CO emissions; to promote catalysis; or to reduce gasoline sulfur.

The following examples merely illustrate the invention. Those skilled in the art will recognize many variations that are within the spirit of the invention and scope of the claims.

### EXAMPLE 1

### Preparation of Additives

MgO powder is slurried in water and acetic acid is added to the slurry such that final MgO-slurry contains 15 weight % solids. Separately, pseudo-boehmite alumina is dispersed in a mixture of acetic acid and water at 10 weight % solids to form an Al-slurry. The MgO and Al-slurries are mixed in proportion to target Mg/Al molar ratio of 4 in the final formulation. Additional water can be used to achieve target solid level in a mixed slurry. The mixed slurry is then heated to about 102° C. for about 2.5 hours to form hydrotalcite-like phase (HTLp). Calcium carbonate (CaCO3) and boric anhydride (B₂O₃) powder is mixed with water to make Ca—B slurry with about 20 weight % solids. The Ca—B slurry is then added to the HTLp slurry and mixed until all ingredients are uniformly mixed. The Ca—B and HTLp mixed slurry is then spray dried under suitable conditions to achieve microspherical powder with average particle size of 70-100 um. The spray dried product undergoes calcination and hydration steps to achieve desired absolute bulk density (ABD) and attrition index (AI) for FCC application. The target composition of final product is 20 weight % CaO, 10 weight % B₂O₃ and balance MgO—Al₂O₃ with Mg/Al ratio of 4. This is referred to as Additive 1.

### EXAMPLE 2

### Level of Active Components

The Example 1 procedure is repeated, with the exception that the additives are prepared with varying level CaCO₃ and B₂O₃ in the formulation. A series of samples, referred to as Additives 2A-2D are synthesized with CaO level up to 20 weight % and B₂O₃ up to 10 weight %. See Table 1. Samples were calcined at 1000° C. and analyzed by XRF analysis. All the additives listed below have acceptable physical properties (e.g., particle size, ABD, attrition) desired for FCC applications.

TABLE 1
COMPOSITION OF ADDITIVES

| Additive | CaO (wt %) | B₂O₃ (wt %) | HTLp (wt %) |
|---|---|---|---|
| Additive 1 | 20.0 | 10.0 | 70.0 |
| Additive 2A | 20.0 | 0.0 | 80.0 |
| Additive 2B | 20.0 | 7.0 | 73.0 |
| Additive 2C | 10.0 | 10.0 | 80.0 |
| Additive 2D | 0.0 | 10.0 | 90.0 |

### EXAMPLE 3

### Deactivation and Activity Evaluation

A catalyst mixture is prepared by physically blending base cracking catalyst and 10 weight % of Additives 1, 2A or 2B. Vanadium and nickel naphthanates were cracked onto each specific catalyst mixture using a commercially available automated deactivation unit. Metalation is performed such that final product contains Ni level of ˜1000 ppm and V level of ˜2000 ppm, with total metal level of ˜3000 ppm. After the completion of metalation step, samples were steam equilibrated with 95% steam at 788° C. for 10 hours. Activity evaluation was performed on a laboratory scale ACE unit (Advanced Cracking Evaluation, Kayser Technology ACE model R+), under relevant FCC conditions (527° C. cracking temperature; WHSV, 21.3 h⁻¹).

Activity data of the base Ecat and Ecat blended with 10 weight % of additives is compared in Table 2 at catalyst-to-oil ratio of 4. Additive 2A, containing only CaO in the formulation, shows reduction in coke, H₂ and dry gas compared to the base Ecat. Furthermore, both the Additives 2B and 1, containing CaO as well as B₂O₃, show even greater reduction in coke, H₂ and dry gas. This clearly demonstrated that addition B₂O₃ to CaO containing metal-trap additives further improves the catalyst performance.

TABLE 2
ACTIVITY TESTING RESULTS

| | Ecat + | Ecat + | Ecat + | Ecat + |
|---|---|---|---|---|
| | no additive | 10% Additive 2A | 10% Additive 2B | 10% Additive 1 |
| Cat/Oil (w/w) | 4.0 | 4.0 | 4.0 | 4.0 |
| Conversion (wt %) | 65.9 | 68.8 | 67.9 | 67.7 |
| Coke (wt %) | 6.0 | 5.7 | 5.0 | 5.1 |
| Dry gas (wt %) | 2.2 | 2.0 | 1.7 | 1.8 |
| H₂ (wt %) | 0.55 | 0.35 | 0.31 | 0.31 |
| LPG (wt %) | 13.4 | 15.2 | 14.8 | 14.3 |
| Total Gasoline (wt %) | 44.4 | 46.0 | 46.4 | 46.5 |
| (IBP-221° C.) | | | | |
| LCO (wt %) | 11.1 | 10.4 | 10.5 | 10.7 |
| (221-282° C.) | | | | |
| MCO (wt %) | 8.2 | 7.3 | 7.6 | 7.7 |
| (282-343° C.) | | | | |
| Bottoms (wt %) | 14.8 | 13.4 | 14.0 | 13.9 |
| (343° C.+) | | | | |

EXAMPLES 4

### Activity at Higher Cat/Oil Ratio

The effect of additives is also tested at a higher catalyst-to-oil ratio of 6 (w/w) and performance in compared in Table 3. Similar to Example 3, both Additives 2B and 1 demonstrate improved performance at higher feed conversion.

TABLE 3
ACTIVITY TESTING RESULTS AT CAT-TO-OIL RATIO OF 6

| | Ecat + | Ecat + | Ecat + | Ecat + |
|---|---|---|---|---|
| | no additive | 10% additive 2A | 10% additive 2B | 10% additive 1 |
| Cat/Oil (w/w) | 6.0 | 6.0 | 6.0 | 6.0 |
| Conversion (wt %) | 72.6 | 74.4 | 73.5 | 72.8 |
| Coke (wt %) | 8.1 | 7.7 | 6.8 | 6.9 |
| Dry gas (wt %) | 2.5 | 2.3 | 2.0 | 2.0 |
| H2 (wt %) | 0.58 | 0.39 | 0.35 | 0.35 |
| LPG (wt %) | 15.1 | 16.9 | 16.2 | 16.1 |
| Total Gasoline (wt %) | 46.9 | 47.6 | 48.5 | 47.7 |
| (IBP-221° C.) | | | | |
| LCO (wt %) | 10.0 | 9.5 | 9.5 | 9.9 |
| (221-282° C.) | | | | |
| MCO (wt %) | 6.6 | 6.0 | 6.3 | 6.5 |
| (282-343° C.) | | | | |
| Bottoms (wt %) | 10.8 | 10.1 | 10.6 | 10.8 |
| (343° C.+) | | | | |

We claim:

1. A metal trapping additive comprising calcium, boron and a magnesia-alumina.

2. The metal trapping additive of claim 1 wherein the magnesia-alumina is a hydrotalcite or hydrotalcite-like material.

3. The metal trapping additive of claim 1 wherein the magnesia-alumina is a mixed magnesium-aluminum oxide.

4. The metal trapping additive of claim 1 comprising 5 to 15 weight percent boron, as measured by B₂O₃.

5. The metal trapping additive of claim 1 comprising 5 to 50 weight percent calcium, as measured by CaO.

6. The metal trapping additive of claim 1 wherein the metal trapping additive has an apparent bulk density within the range of from 0.7 to 0.95 g/cc.

7. The metal trapping additive of claim 1 wherein the metal trapping additive has an average particle size ranging from 70 to 110 microns.

8. A process for the catalytic cracking of feedstock comprising contacting the feedstock under catalytic cracking conditions with a FCC catalyst and a metal trapping additive comprising calcium, boron and magnesia-alumina.

9. The process of claim 8 wherein the magnesia-alumina is a hydrotalcite-like material.

10. The process of claim 8 wherein the magnesia-alumina is a mixed magnesium-aluminum oxide.

11. The process of claim 8 wherein the FCC catalyst comprises a zeolite.

12. The process of claim 8, wherein the zeolite is zeolite X, Y zeolite, zeolite A, zeolite L, zeolite ZK-4, beta zeolite, ZSM-5 zeolite, or a combination thereof.

13. The process of claim 8 wherein the metal trapping additive comprises 5 to 15 weight percent boron, as measured by B₂O₃.

14. The process of claim 8 wherein the metal trapping additive comprises 10 to 35 weight percent calcium, as measured by CaO.
